(19) United States
(12) Patent Application Publication
(10) Pub. No.: US 2009/0169311 A1
(43) Pub. Date: Jul. 2, 2009

(54) Containment structure

(76) Inventors: Paul Sharley, Hengoed (GB); Basil Thomas, Abergavenny (GB)

Correspondence Address: WEIDE & MILLER, LTD., 7251 W. LAKE MEAD BLVD., SUITE 530, LAS VEGAS, NV, 89128, US

(21) Appl. No.: 12/321,067

(22) Filed: Jan. 13, 2009

Related U.S. Application Data
(63) Continuation of application No. PCT/GB2007/002502, filed on Jul. 3, 2007.

(30) Foreign Application Priority Data
Jul. 15, 2006 (GB) 0614132.9

(51) Int. Cl. E02D 31/00; E04B 1/00; B32B 37/00; G06K 19/00

(52) U.S. Cl. 405/302.6; 52/741.4; 156/60; 235/487

(57) ABSTRACT

A particulate material containment structure and a method of manufacturing such a structure are provided herein. The structure may comprise an open-cell matrix and an intermediary composite comprising particulate material retained in a support matrix, wherein the intermediary composite is retained within the open-cell matrix. In various embodiments, the structure may comprise at least one textile layer, such as a geotextile layer. The present invention has particular application in preventing the phenomenon known as pumping erosion.

### CROSS-REFERENCE TO RELATED APPLICATIONS

This application claims priority to PCT Application No. PCT/GB/2007/002502 titled Containment Structure, filed Jul. 3, 2007, which claims priority to Great Britain Application No. 0614132.9, filed Jul. 15, 2006.

### BACKGROUND OF THE INVENTION

1. Field of the Invention

The present invention relates to a containment structure, and in particular the invention relates to a particulate material containment structure, a method of manufacturing such a structure and uses of such a structure.

2. Related Art

Pumping erosion is the result of train axle loads rippling along a railway track. The rapid sequential loading and unloading of rail sleepers caused by a moving train transmits a pulsating load to the ballast/sub-base interface. Accordingly, where a track is built on a fine clay/silt sub-base, this pulsating load may cause the surface of the clay/silt to liquefy when wet, and may subsequently be forced upwards into the ballast layer. This undesirable breakdown and movement of the clay/silt base layer has the potential to cause distortion of the whole track structure. The problem of pumping erosion is common to the majority of countries across the globe who experience regular rainfall conditions and is singularly the most common cause of track failure.

From the discussion that is to follow, it will become apparent that the containment structure of the present invention addresses the deficiencies associated with the prior art while providing numerous additional advantages and benefits not hitherto contemplated or possible with prior art constructions.

### SUMMARY OF THE INVENTION

Although the containment structure of the present invention has various different uses, it has particular advantages in the field of rail construction and the like. More specifically, some embodiments of the present invention aim to address the problems associated with the phenomenon known as “pumping erosion”.

In a first aspect of the present invention there is provided a particulate material containment structure, comprising: an open-cell matrix, an intermediary composite comprising particulate material retained in a support matrix, and at least one blanket of the intermediary composite. The intermediary composite may be retained within the open-cell matrix. There is therefore provided, essentially, a matrix within a matrix.

At least part of the structure may be porous. Further, the whole or at least part of the structure may be permeable or impermeable dependent on the intended application.

The support matrix within the containment structure may be formed from a curable material. The support matrix may therefore shrink significantly whilst curing, causing it to recede from significant portions of the surface area of individual particles within the structure. Thus, the natural porosity and surface characteristics of the original loose particulate material may be substantially preserved.

The particulate material containment structure may be flexible. Preferably the support matrix is flexible. Such flexible properties may allow the containment structure to be supplied in a roll form, thus enabling the particles to be easily transported and uniformly distributed or positioned. The containment structure could substantially retain the physical characteristics of an equivalent thickness of the original particulate material.

The support matrix may be elastic. Accordingly, the containment structure may withstand substantial displacement in the lateral and longitudinal directions whilst being able to retain the particulate material configuration contained therein. The elastic support matrix fulfils the purpose of maintaining the placement of individual aggregate particles within the whole structure whilst imparting a high degree of flexibility into the aggregate component.

The support matrix may comprise a bonding agent, such as an adhesive. The adhesive may be rubber-based. The rubber material may be a natural rubber, for example, a latex rubber. Alternatively, the rubber material may be a synthetic rubber. Both natural rubbers and synthetic rubbers are readily and cheaply available and therefore production costs of a containment structure of this type are minimized. Alternatively, the bonding agent may be a non-flexible resin comprising flexible particles, the particles being formed from rubber for example.

The particulate material and adhesive may be mixed and formulated such that individual particles are lightly coated with adhesive ensuring that the spaces between adjacent particles remain open to the passage of liquids or gasses. Furthermore, the employed adhesive may shrink significantly whilst curing causing it to recede from significant portions of the surface area of individual particles within the structure, thereby retaining the natural porosity of loose particulate material. A suitable adhesive may be liquid latex rubber but any flexible bonding agent may be employed.

The particulate material may be selected on the basis that, in use, it is capable of odor absorption. This property of the particulate material is particularly important for the containment structure in its application encompassed by the present invention as a protective layer to an impermeable membrane used to envelop a landfill cell or the like. For example, in this application the particulate material may absorb unpleasant odors emanating from leachate or gasses residing in the vicinity of landfill cells or the like.

The particulate material may be a natural or synthetic material. The containment structure may therefore be more versatile in terms of its end use and in terms of the materials from which it may be manufactured.

The particulate material may be at least one selected from sand, zeolite, recycled glass, carbon or the like. The particulate material containment structure may contain a combination of two or more different particulate materials, such as sand and zeolite for example.

The particulate material may be formed from spherical particles or amorphous particles. For example, spherical particulate material may be preferred due to its ability to provide a uniform distribution of particles in a lattice-like configuration. Alternatively, amorphous particles may be preferred due to their irregular shape which may provide a non-complimentary stacking configuration thereby enhancing the natural porosity of the particulate material.

The particulate material may be uniformly distributed throughout the intermediary composite. A uniform distribution may provide a consistent performance of the containment structure.

The appropriate bonding agent to particulate material mixing proportions may depend on a number of application specific factors which may include: the aggregate particle shape, size and type; the bonding agent type; the degree of porosity required; the degree of flexibility required for the end use of the containment structure; and the surface exposure ratio of the aggregate particulate material required, most particularly for odor absorption applications.

The ratio of the bonding agent to the particulate material may range from 1:7 to 1:15. Preferably, the mixing ratio is such that sufficient bonding agent is applied to coat at least some part of the surface of each aggregate particle during a mixing process but insufficient to fill the voids between the particles, thereby retaining as many as possible of the natural physical properties of the loose particulate material.

The mean mass aerodynamic diameter of the particulate material may range from 0.075 mm to 2.6 mm. The size of the particulate material may be dependent upon the intended application of the containment structure. For example, to obtain the optimal filtering performance of the containment structure a different size of particulate material may be employed to filter materials varying in size and shape.

The containment structure may have a minimum bend radius which ranges from 50 mm to 500 mm. The flexibility of the containment structure may be dependent upon its function or intended use.

The particulate material may be uniformly distributed throughout the intermediary composite, thereby enhancing the consistency of the performance of the containment structure.

The open-cell matrix may be formed from a natural or synthetic material. The open-cell matrix may be formed from a plastics material, such as polyethylene.

The particulate containment structure may be provided with a flexible open-cell matrix, for example. The open-cell matrix, in use, may be capable of withstanding a compressive load whilst substantially maintaining the positional integrity of the particulate material retained within the intermediary composite of the structure. For example, in its rail track application, the particulate containment structure, more specifically the open-cell matrix, may withstand the compressive load applied by a load bearing train which moves over the sleepers overlaying the containment structure. Preferably, the containment structure is able to substantially retain the positional integrity of the particulate material thereby preventing the particulate material from spreading outwardly towards less stress bearing locations within the rail track construction. A spreading of particulate material may have the effect of weakening a particular position of the containment structure, and ultimately the rail track structure.

The open-cell matrix may be shaped as a uniform grid. Alternatively, the open-cell matrix may be formed from randomly positioned strands.

An intermediary composite comprising particulate material retained within a support matrix, such as an adhesive, may be inter-dispersed throughout the open-cell matrix and held therein. The intermediary composite may mechanically interlock with the open-cell matrix, but to which it may not necessarily adhere. Alternatively, the intermediary composite may adhere to the open-cell matrix.

The particulate material containment structure may further comprise at least one blanket of intermediary composite. The blanket or continuous layer of intermediary composite may be located adjacent a major surface of the open-cell matrix. By overlaying the open-cell matrix with a blanket of the intermediary composite the filtration capabilities of structure may be enhanced.

The particulate material containment structure may further comprise a wetting agent. Wetting agents or “chemical wetting agents”, as they are commonly known, may be added to the intermediary composite during the manufacturing process to modify the liquid absorption and flow characteristics of the particulate material contained therein.

The intermediary composite may be uniformly distributed within the open-cell matrix. By doing so, a consistent performance of the containment structure may be provided.

The particulate material containment structure may further comprise at least one textile layer. In this way, a combination of the open-cell matrix and the intermediary composite may be sandwiched between at least two textile layers.

The textile layer may be provided by a natural or synthetic material. The textile layer may be provided by a woven material, thereby enhancing the textile layer strength. The textile layer may be flexible and may therefore provide a high degree of movement to the containment structure.

The textile layer may be detachably attached to the open-cell matrix. Alternatively, the textile layer may be permanently fixed to the open-cell matrix. The textile layer may be attached to the open-cell matrix by means of lamination, such as flame lamination, offering the benefits of high shear resistance to the containment structure and excellent cohesive bonding between the textile layer and open-cell matrix.

In use, the textile layer may be capable of spreading a load imparted on the containment structure. The spreading of a load imparted on the structure may improve the longevity of the structure and also prevent the appearance of weak areas within the structure which may be generated by repeated application of force imparted by the load on a particular location.

The textile layer may be a geotextile layer. Geotextiles are permeable fabrics which when used in association with soil for example, have the ability to separate, filter, reinforce, protect and drain liquid or gaseous matter.

The particulate material containment structure may further comprise staple fibers. Staple fibers may increase the strength and robustness of the overall structure, thus providing additional stability. The staple fibers may be thread-like structures and may exhibit a reinforcing effect, thereby enhancing the longevity of the containment structure.

The particulate material containment structure may further comprise radio frequency identification means. Radio frequency identification (RFID) is an automatic identification method, relying on storing and remotely retrieving data using devices called RFID tags or transponders. Such data may include information relating to the position and date of installation of the containment structure together with information on other important features, such as the location of underground pipes, for example, which may be found within the surrounding area.

The present invention also comprehends a method of manufacturing a particulate material containment structure, the structure being porous, and the method comprising the steps of: forming an intermediary composite comprising particulate material retained in a support matrix, adding the intermediary composite to an open-cell matrix for containment therein, and providing at least one blanket of the intermediary composite.

The particulate material may be at least one selected from sand, zeolite, recycled glass, carbon or the like. The method of the present invention may allow for the particle constituents to be varied to incorporate any combination of mineral/particle type material. These may include anti-bacterial, anti-microbial, gas neutralization, ultra absorbent particles, for example. This may allow the structure to act as a protective layer or gas barrier in landfill or remedial construction.

The method may further comprise the step of laminating (for example by flame laminating) at least one textile layer to the open-cell matrix. The textile layer may be a geotextile layer.

The textile layer may be rolled onto the open-cell matrix during the lamination procedure. In this way, a continuous layer of textile may be applied to the open-cell matrix when positioned on a conveyor belt, for example.

The method may further comprise the step of utilizing a thickness adjustment means to select the thickness of the containment structure. The thickness adjustment means may be a mangle or grading blade, for example. The thickness of the containment structure may be dependent upon the use for which it is intended. For example, a containment structure which requires a high level of flexibility for its end use may be adjusted so that it has a low level of thickness.

The structure may be of substantially uniform thickness. Alternatively, the thickness may vary along and/or across the length of the structure. This would allow the formation of, for example, grooves, depressions, interlocking structures and the like.

A containment structure provided in accordance with this method may comprise a bonding agent, as hereinbefore described.

The method of the present invention may include a sequence of steps comprising the lamination of one textile layer to the open-cell matrix, thereby defining filling pockets for receiving the intermediary composite within the open-cell matrix, followed by the addition of the intermediary composite. The sequence may include an additional step of laminating a second textile layer to the opposing side of the open-cell matrix, thereby sandwiching the open-cell matrix between the two textile layers for containment of the particulate material therein. Alternatively, the second textile layer may be fixed to the open-cell matrix by means of an adhesive.

The method of the preset invention may be employed for the manufacture of any of the particulated containment structures described herein.

In another aspect of the present invention there is provided a railway trackbed liner, comprising a containment structure as described hereinbefore, the liner being suitable for use in railway track construction to provide a consistent thickness of particulate material over an undulating surface for the regulation of migration of residing sub-base materials and the drainage of precipitation.

In a further aspect of the present invention there is provided a landfill cell liner, comprising a containment structure as described hereinbefore, the liner being suitable for use in the protection of an impermeable membrane used to envelop a landfill cell or the like. In this application the containment structure may act as a protective barrier to prevent the puncture of an impermeable membrane, which is itself designed to prevent leachate or gas from escaping into the environment. In this application a suitable particulate material may be recycled glass, for example. The landfill cell liner may be positioned adjacent a major surface of the impermeable membrane. Alternatively or additionally, zeolite may be preferred due to its ability to neutralize escaping gasses, such as methane.

The present invention also comprehends a building composite, comprising a containment structure as described hereinbefore, the composite being suitable for use in the construction of a landfill cell, or the like, having substantially upright walls. By lining the interior surface of a landfill cell, or the like, it may be possible to increase the angle between the base and wall of a conventional landfill cell thereby increasing its capacity. By increasing the capacity of a landfill cell and allowing the walls to be substantially upright, the ground in a landfill area may be utilized more efficiently. The embankment angle or wall angle of a landfill cell, for example, may be increased due to the high coefficient of friction that the present invention generates when contacting another surface. The present invention may, in this application, act to retain the shape of the landfill cell, or the like, wall. The landfill cell, or the like, wall may otherwise collapse or cave-in when the angle between the base and wall is increased to a value which may be accommodated by the present invention. The present invention may therefore provide a support to the substantially upright walls.

It will be understood that the present invention may be used to support walls, or the like, in other applications from those described hereinbefore.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a part cut away perspective view of a containment structure formed in accordance with the present invention;

FIG. 2 is a view similar to that shown in FIG. 1 of an alternative embodiment of the present invention;

FIG. 3 is a similar view to that shown in FIGS. 1 and 2 of an alternative embodiment of the present invention;

FIG. 4 is a cross-sectional view of a containment structure formed in accordance with the present invention in use;

FIG. 5 is a plan view of an open-cell matrix and a textile layer;

FIG. 6a is a schematic diagram of a manufacturing process according to the present invention;

FIG. 6b is a schematic diagram of an alternative manufacturing process according to the present invention;

FIG. 7 displays a landfill cell liner of the present invention in a landfill cell application;

FIG. 8 is a view similar to that shown in FIG. 7 of an alternative embodiment of the present invention;

FIG. 9 illustrates a side elevation of a building composite of the present invention being used to provide a plurality of efficiently spaced settling ponds;

FIG. 10 displays an alternative embodiment of a building composite formed in accordance with the present invention;

FIG. 11 is a side elevation of a containment structure formed into a roll for transport/storage purposes;

FIG. 12 is a cross-section of an alternative containment structure;

FIG. 13 is a side elevation of a joint between two adjacent structures formed according to the present invention;

FIG. 14 is a view similar to that shown in FIG. 12, but illustrating an alternative joint;

FIG. 15 is a further embodiment of the joint between adjacent rolls or panels;

FIG. 16 is a still further alternative embodiment of the joint between adjacent rolls or panels;

FIG. 17 is a perspective view of a containment structure formed according to an alternative embodiment of the present invention; and

FIG. 18 is a perspective view of a containment structure formed according to a still further embodiment of the present invention.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

At present the problem of pumping erosion is resolved by the application of a 100 mm thick bed of appropriately graded sand installed at the interface of the stone ballast and the clay/silt base layers. Sand is used because of its natural ability to filter clay and silt type soils through natural bridging. Further, the sand barrier allows water to drain freely from the clay surface whilst controlling the upward migration of clay particles.

Recent studies have shown, however, that the actual level of migration of clay particles into this type of sand barrier is minimal. For example, the extent of migration into the sand barrier may be in the region of 1 mm to 2 mm and, therefore, the thickness of the sand layer may be substantially reduced whilst still being able to perform its intended function. Due to the properties of dry particulate aggregates, such as sand, which include them having free-flowing or liquid characteristics, they are thus difficult to constrain within the structure of a composite. Having regard for this difficulty together with the appreciation that a rail track may be built over an undulating surface, at present it is preferred that a 100 mm thick bed of sand is installed to ensure that a minimum thickness of sand, say 10 mm to 15 mm, is present along the entirety of the rail track construction for effective cover. Such an overzealous application of sand appears to take account for the inconsistent thickness of sand which may be applied over the clay/silt layer during manual installation by different workers. Both the thickness of the sand presently used and the labor intensive installation results in a costly procedure for the prevention of pumping erosion.

The present invention allows particulate material, such as sand, to be contained within a structure thereby providing means for installing a consistent layer thickness over an undulating surface. By ensuring that a known quantity of particulate material, such as sand, is installed per unit area of track-bed this allows a much thinner layer of sand to be applied than conventional methods, thereby reducing material costs. Further, a containment structure of this type also allows the particulate material to be positioned and installed in a much quicker and efficient manner than installation methods associated with the prior art. Because the containment structure may be fixed at a predetermined thickness during manufacture there is no requirement for the installer to approximate the thickness of the particulate material layer, as could be the case during a manual installation of loose particulate material. It is noted that in some embodiments the structure could be defined as a particulate material immobilization structure.

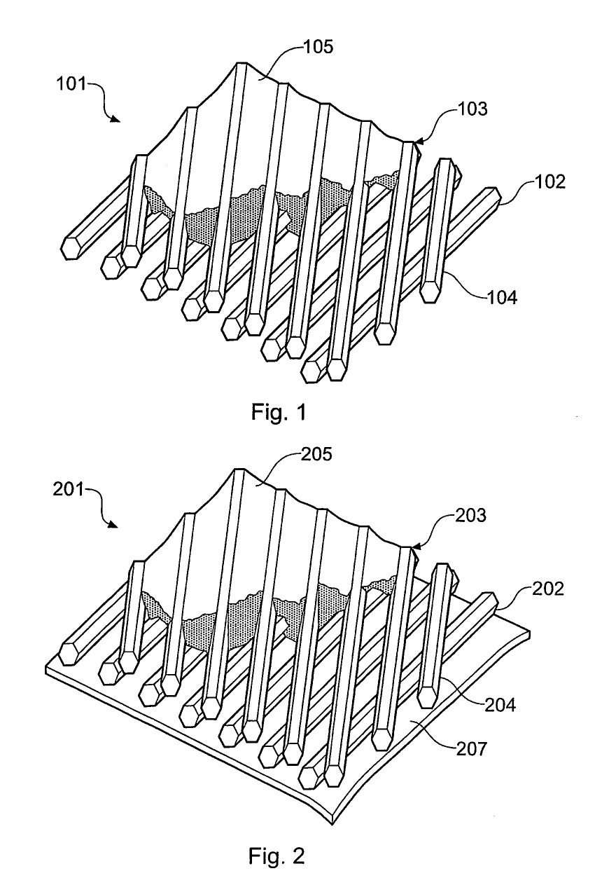

Referring to FIG. 1 there is shown a particulate material containment structure, generally indicated 101. The particulate material containment structure will hereinafter be referred to as “containment structure”. The containment structure 101 is permeable and comprises an open-cell matrix 103 and an intermediary composite 105 supported therein. The intermediary composite 105 itself comprises particulate material retained within a support matrix. In this embodiment the particulate material used is sand and the support matrix is provided by a liquid latex rubber adhesive. The sand particles are uniformly distributed throughout the adhesive.

The open-cell matrix 103 is provided by an extruded plastic, more specifically polyethylene, diamond shaped net-like structure. The open-cell matrix 103 is substantially planar and comprises two rows (102 and 104), one placed above the other, of parallel and spaced plastic strands, wherein the rows are integrally formed. The first row 102 is obliquely angled with respect to the second row 104 thereby defining the diamond shaped voids between the rows, and ultimately forming the net-like open-cell matrix 103.

The intermediary composite 105, comprising the sand and adhesive mix, is uniformly inter-dispersed throughout the open-cell matrix 103. The open-cell matrix 103 provides support to the intermediary composite 105, more specifically the sand particles; the sand particles themselves being supported within and immobilized by the three dimensional matrix provided by the liquid rubber latex adhesive. In this embodiment, the intermediary composite 105 rests within the dimensions defined by the open-cell matrix 103. However, the present invention also envisages a containment structure in which the intermediary composite is supported by the matrix but is not necessarily wholly contained within the dimensions of the matrix. In other words, the body of composite material may extend beyond the notional boundaries defined by the matrix structure. The open-cell matrix 103 is flexible, thus allowing the containment structure 101 to be supplied in roll form. However, it also displays a high degree of vertical stiffness to resist the effects of compressive loads which may be applied during its use.

Whilst the liquid rubber latex adhesive supports the sand particles and helps maintain their positional integrity within the containment structure 101, the adhesive, once cured, shrinks and therefore does not envelop the entire surface of each sand particle. The resultant effect is that spaces or voids are present between the sand particles thereby maintaining a natural porosity, which would otherwise be present in loose particulate material. The porosity of the sand allows for drainage of precipitation, such as rainfall. In use, the containment structure 101 is therefore able to reduce the amount of water which may contact water absorbent surfaces, such as clay/silt based layers, which can cause erosion pumping.

Now referring to FIG. 2 there is shown a containment structure 201, similar to that shown in FIG. 1, further comprising a laminar first geotextile layer 207. The first geotextile layer 207 is located on the lower major surface of the planar open-cell matrix 3 as shown in the drawing. The first geotextile layer 7 is attached to the first row 202 of the open-cell matrix 203 by means of flame lamination.

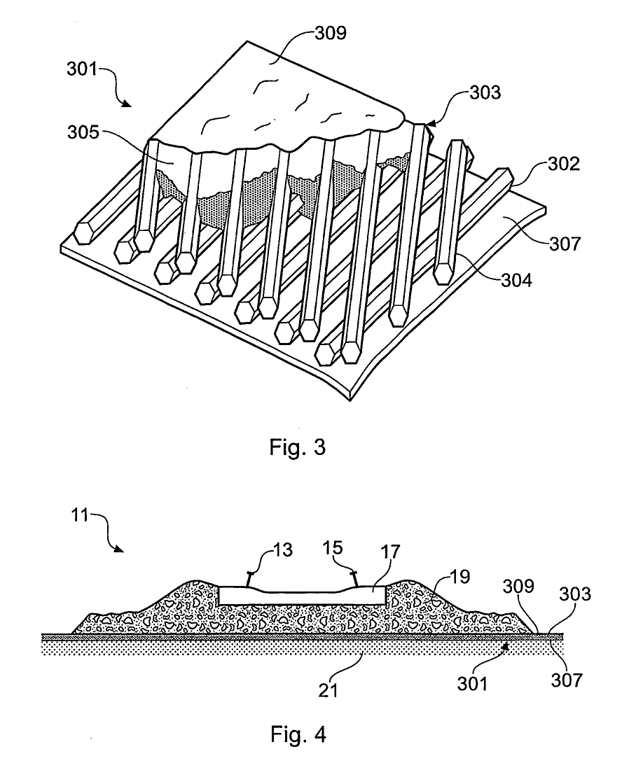

Now referring to FIG. 3 there is shown a containment structure 301, similar to that shown in FIG. 2, further comprising a laminar second geotextile layer 309. The second geotextile layer 309 is bound to the upper major surface of the planar open-cell matrix 303, as shown in the drawing, by means of an adhesive. The first and second geotextile layers 307 and 309 respectively, sandwich the open-cell matrix 303 and intermediary composite 305 therebetween. The first and second geotextile layers 307 and 309 are porous and provide additional filtration properties to the containment structure 301 whilst also protecting the open-cell matrix 303 and intermediary composite 305.

Now referring to FIG. 4 there is shown a cross-section of a rail track structure, generally indicated 11. The rail track structure 11 comprises a pair of parallel rails 13 and 15, and a plurality of sleepers 17 (one shown in drawing). The rails 13 and 15 are fixed at a predetermined distance apart by the underlying sleepers 17. The rail track structure 11 is built over a track bed which is provided by a ballast layer 19. The ballast layer 19 consists of gravel, cinders or other aggregates. Beneath the ballast layer 19 may be found the clay sub-base layer 21. The ballast layer 19 and the clay sub-base layer 21 are separated at their interface by the containment structure 301. In this embodiment, the containment structure 301 as shown in FIG. 3 is utilized. The containment structure 301, therefore, comprises both a first geotextile layer 307 and second geotextile layer 309, thus providing additional support and protection to the contained particulate material.

The porous nature of the containment structure 301 facilitates the drainage of any precipitation, such as rainfall, which may percolate through the ballast layer 19. By minimizing the amount of water which reaches the clay sub-base layer 21, lying beneath the containment structure 301, generation of liquefied clay under conditions of a compressive load may be reduced thereby mitigating the effects of erosion pumping.

The containment structure 301, in this embodiment, comprises an open-cell matrix 303 having a thickness in the region of 6 mm. This substantial reduction in thickness of the particulate material layer when compared to a conventional 100 mm layer of loose particulate material is possible because recent studies have shown that the actual upward migration of clay particles from the clay sub-base layer 21 is in the region of 1 mm to 2 mm. Further, due to the intermediary composite 303, of the containment structure 301, comprising a liquid latex rubber adhesive which shrinks during curing, the natural porosity of the particulate material within the containment structure 301 is retained. The containment structure 301 ensures that at least 1 mm to 2 mm of particulate material, required for this function, is present throughout the interface of the ballast layer 19 and the clay sub-base layer 21. Furthermore, the containment structure 301 is adjusted to a predetermined thickness before installation, avoiding the possibility of an inconsistent application of particulate material which may be possible with processes of the prior art.

The present invention therefore provides means for addressing the problems associated with erosion pumping whilst substantially reducing the amount of materials required to perform this function, improving the ease of installation of particulate material of this type and ultimately reducing the costs of manufacturing and installing the particulate material.

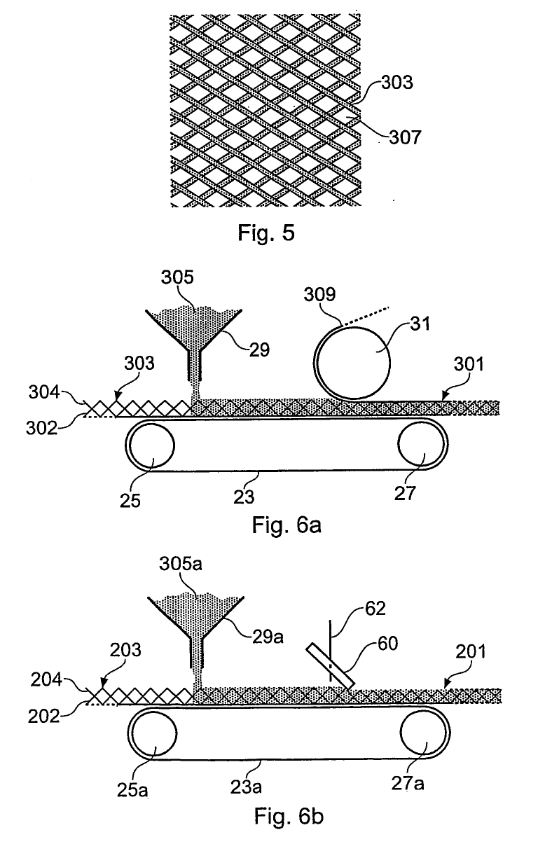

FIGS. 5, 6a and 6b relate to a method of manufacture of the present invention.

In FIG. 5 there is shown a plan view of an open-cell matrix 303 and a first geotextile layer 307 attached thereunder. The open-cell matrix 303 has a net-like structure with diamond shaped voids, through which the lower geotextile layer 307 may be observed.

In this embodiment of the method of the present invention a first geotextile layer 307 is attached to the lower face of the open-cell matrix 303, thereby creating an open pocketed structure. In alternative embodiments of the invention the containment structure 301 may be provided without the first geotextile layer 307, comprising solely of the intermediary composite 305, for example. The open-cell matrix 303, together with the first geotextile layer 307, shown in FIG. 5 represents the first stage of manufacturing the containment structure 301.

Referring now to FIG. 6a there is shown a schematic side elevation which represents the subsequent steps in the manufacturing process of the containment structure 301. The open-cell matrix 303 and first geotextile layer 307, of FIG. 5, is placed on a conveyor belt 23, which comprises a left roller wheel 25 and a right roller wheel 27. Both the left roller wheel 25 and the right roller wheel 27 rotate in a clockwise direction thereby driving the supported conveyor belt 23 also in a clockwise direction.

From the view shown in FIG. 6a, the open-cell matrix 303 and the first geotextile layer 307, of FIG. 5, move along the conveyor belt 23 in a rightwardly direction. The lower geotextile layer 307 being attached to the first row 302, of the open-cell matrix 303, whilst also making contact with the conveyor belt 23, thereby exposing a pocketed net from the upper surface of the open-cell matrix 303. Thus, in a subsequent step of the method of the present invention, the open-cell matrix 303 is able to receive the intermediary composite 305 from above. Accordingly, the intermediary composite 305, in this embodiment comprising of sand particles and liquid rubber latex adhesive, is located inside a dispensing hopper 29, positioned above the conveyor belt 23. As the open-cell matrix 303 and first geotextile layer 307 attached thereto move along the conveyor belt 23, the intermediary composite 305 is dispensed into the pockets of the open-cell matrix 303. A uniform distribution of intermediary composite 305 may be obtained by maintaining a constant dispensing rate from the dispensing hopper 29 together with a constant rate of movement of the conveyor belt 23.

The subsequent step of the method of the present invention comprises the open-cell matrix 303, having been filled with the intermediary composite 305, and first geotextile layer 307 attached thereto, moving through a thickness adjustment means, here an adjustment mangle roller 31. The adjustment mangle roller 31 rotates in an anti-clockwise direction and is also capable of movement in the vertical direction. In this embodiment the adjustment mangle roller 31 comprises the planar second geotextile layer 309 which is fed onto its outer surface.

By a vertical height adjustment of the adjustment mangle roller 31 the gap between the adjustment mangle roller 31 and the conveyor belt 23 may be selected. In this way, the thickness of the oncoming open-cell matrix 303 filled with intermediary composite 305 and attached to a first geotextile layer 307, which must pass through the gap between the conveyor belt 23 and the adjustment mangle roller 31, may be selected. In addition, the second geotextile layer 309 may be rolled onto the second row 304 of the open-cell matrix 303 and fixed thereto by means of an adhesive.

Following the thickness adjustment of the containment structure 301, the subsequent step of the method of the present invention involves the application of heat (not shown) onto the outer surface of the second geotextile layer 309 so that it may cure the bonding agent contained therein.

At the end of the conveyor belt 23 there is manufactured a particulate material containment structure 301, comprising an open-cell matrix 303, intermediary composite 305, a first geotextile layer 307 and a second geotextile layer 309.

Now referring to FIG. 6b there is shown a schematic diagram similar to that of FIG. 6a, but of an alternative embodiment of the present invention. In this embodiment the thickness adjustment means is provided by a grading blade 60, which is inclined at 45° with respect to the conveyor belt 23a. The grading blade 60 has a sharp edge which makes contact with the containment structure 201 passing thereunder, and acts to grade the containment structure 201 to the required thickness. The grading blade is provided with height adjustment means 62, whereby the thickness of the containment structure may be selected. In this embodiment, the containment structure 201 (as shown in FIG. 2) is not provided with a second geotextile layer.

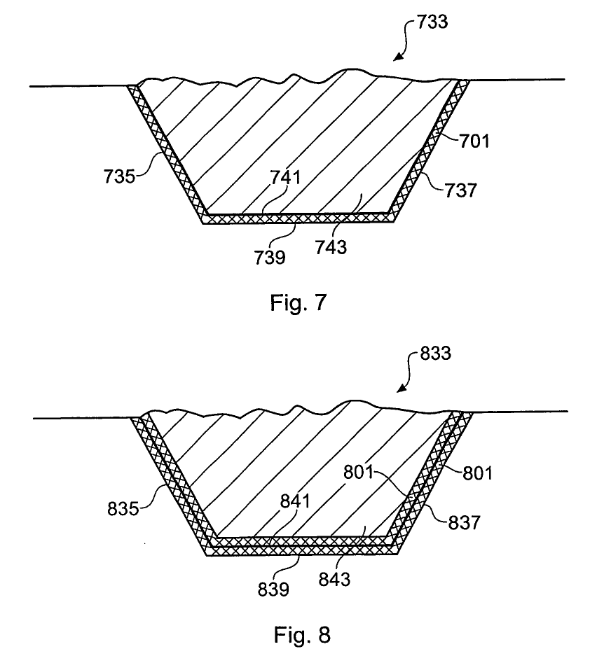

Referring now to FIG. 7 there is shown a landfill cell, generally indicated 733. The landfill cell 733 comprises a pair of inclined walls 735 and 737, and a landfill base 739. The interior surface of the walls 735 and 737 and base 739 are lined with an impermeable containment structure 701. The interior surface of the impermeable structure 701 is, itself, lined with an impermeable membrane 741, the impermeable membrane 741 housing landfill waste 743. In this application, the containment structure 701 acts as a protective barrier to the impermeable membrane 741 thereby preventing any damage which may be caused to the impermeable membrane 741, such as a puncture from sharp objects contained within the ground, for example. In this embodiment, the particulate material may be provided by recycled glass, for example.

Referring now to FIG. 8 there is shown another application of the landfill cell liner as shown in FIG. 7. In this embodiment, the landfill cell 833 is lined with two layers of the landfill cell liner, represented by containment structure 801, at the interior surface of the impermeable membrane 841. The containment structure 801 thereby provides additional protection to the impermeable membrane 841, thus preventing hazardous gasses and leachate from escaping from within the landfill waste 843. Further, the interior layer of containment structure 801 provides additional protection to the impermeable layer 841 by preventing damage, such as a puncture, which may be caused by sharp landfill waste 843 contained therein.

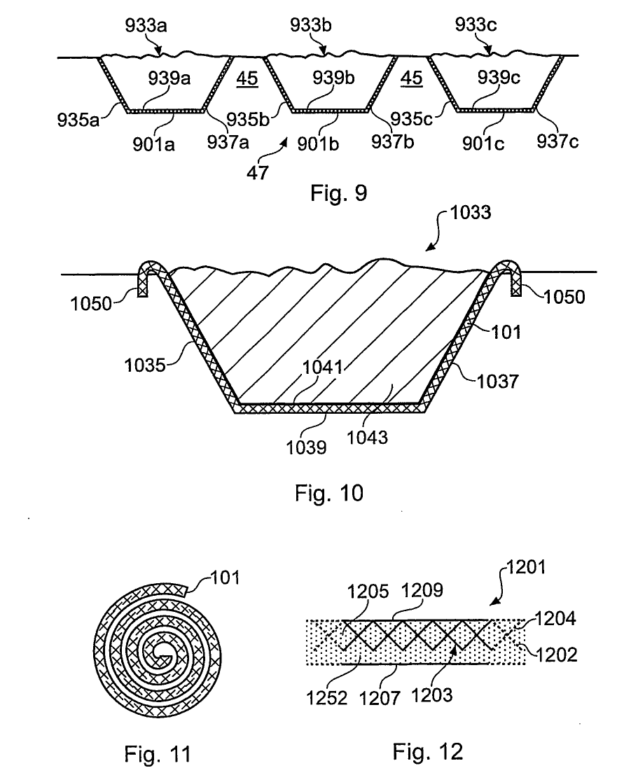

Referring now to FIG. 9 there is illustrated an additional use of the present invention in a settling pond application. Cross sections are shown of three settling ponds 933a, 933b and 933c. Each settling pond has a pair of inclined walls 935 and 937, and a base 939. The number of each wall or base has a suffix ‘a’, ‘b’ or ‘c’ depending on which settling pond 933a, 933b, or 933c they are attributed to. The interior surface of the walls 935a and 937a, and base 939a are lined with a containment structure 901a, the containment structure 901a being porous. The interior surface of the walls 935b and 937b, and base 939b are lined with a containment structure 901b, the containment structure 901b being permeable. The interior surface of the walls 935c and 937c, and base 939c are lined with a containment structure 901c, the containment structure 901c being impermeable.

The incline in settling pond walls of conventional settling ponds lies in the region of 30° to 35°. In this embodiment, each of the settling pond walls 935a/b/c and 937a/b/c are inclined at an angle of 45°. The increased angle of incline of these walls is made possible by use of the containment structure 901 a/b/c which, in this embodiment, acts as a building composite capable of exhibiting a high co-efficient of friction. The building composite has the effect of retaining the shape of the settling pond walls 935a/b/c and 937a/b/c, thereby preventing them from cascading, which would most probably be the case if a settling pond was dug into the ground without lining the interior surface with a containment structure 901 a/b/c of the present invention. It can be appreciated that the volume of the pillar of soil 45 located between adjacent settling ponds 933a/b/c is reduced due to the increased angle of incline of the settling pond walls 935a/b/c and 937a/b/c, when compared to the incline of walls of conventional settling ponds. The enhanced angle of incline of the walls 935a/b/c and 937a/b/c allows the ground of the settling ponds area, generally indicated 47 to be utilized more efficiently.

Referring now to FIG. 10 there is shown a cross section of a landfill cell, similar to that shown in FIG. 7. In this embodiment, all the features of FIG. 7 are retained except that the length of the landfill cell building composite, represented by the containment structure 101, is greater so that it extends over the edge of each wall 1035 and 1037 and hooks into the ground 1050 located adjacently thereto. The purpose of this being to substantially enhance the capability of the containment structure 101 to retain its position, in use, with respect to each wall 1035 and 1037 when acting as a landfill cell building composite thereby allowing the formation of substantially upright walls in a landfill cell application.

Now referring to FIG. 11 there is illustrated a cross section of the laminar containment structure 101 in a stowed posited. Here, the containment structure 101 takes the form of a roll thereby adopting an efficient shape for storage and transportation thereof.

Referring now to FIG. 12 there is shown a schematic side elevation of an alternative embodiment of the present invention. The containment structure, generally indicated 1201, is similar to that shown in FIG. 3. However, in this embodiment the containment structure further comprises an intermediary composite blanket 1252 between the first geotextile layer 1207 and the first row 1202 of the open-cell matrix 1203. The intermediary composite blanket 1252 has the effect of enhancing the filtering properties of the containment structure 1201. This is because the intermediary composite blanket 1252 provides a continuous layer of particulate material, unlike the intermediary composite 1205 which is interspaced between the first (1202) and second (1204) rows of the open-cell matrix 1203.

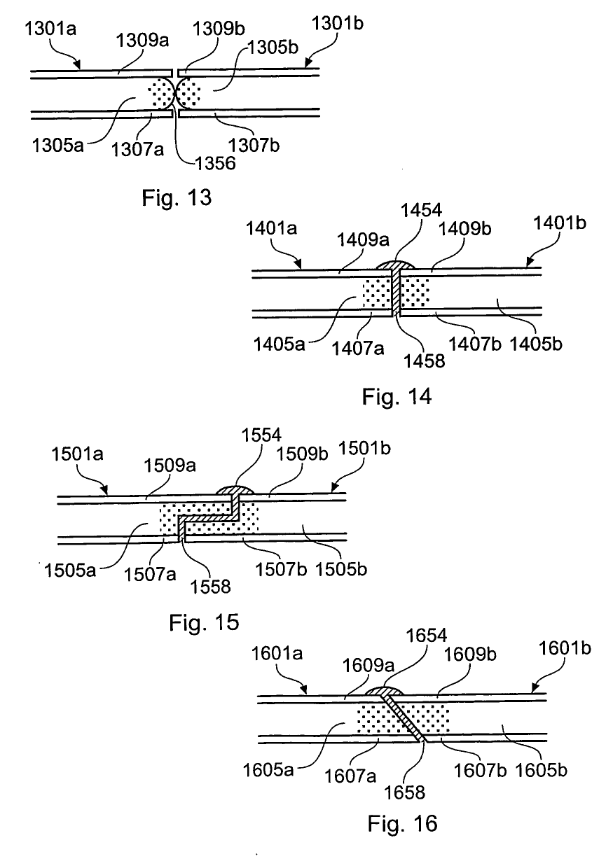

Referring now to FIG. 13 there is shown a side elevation of a joint between two ends 1301a and 1301b of rolls or panels of the containment structure of the present invention. Ends 1301a and 1301b comprise a first geotextile layer 1307, a second geotextile 1309 and intermediary composite 1305 held therebetween (note—open cell matrix not shown in this diagram). Each component is labeled with a suffix ‘a’ or ‘b’, depending on which end 1301a or 1301b they are attributed to. This embodiment shows a self sealing joint, in that the ends are initially spaced but upon application of a downward force onto the second geotextile layers 1309a and 1309b, the intermediary composite 1305a and 1305b, of adjacent ends, spreads sideways and is forced together thereby creating the seal 1356. The seal 1356 improves the efficiency of the containment structure by providing a continuous layer of sand, even between joints, at the clay/ballast interface.

Now referring to FIG. 14, there is shown a view similar to that of FIG. 13, of an alternative embodiment of the present invention. In this embodiment, adjacent ends 1401a and 1401b of separate rolls or panels of containment structures of the present invention, are placed side by side, having a gap 1458 therebetween. The gap 1458 is filled with a mixture 1454 of loose sand and bentonite. The loose sand/bentonite mix 1454 ensures that an effective seal is provided between adjacent ends 1401a and 1401b during application of the rolls or panels over the ground. The joint between adjacent ends could otherwise be prone to leakage of clay silt particles, from below and between the joint, thereby leading to pumping erosion.

Now referring to FIG. 15 there is shown an alternative joint between adjacent ends 1501a and 1501b of rolls or panels of containment structures of the present invention. In this embodiment, the joint is a step joint, in that part of the intermediary composite 1505a and second geotextile layer 1509a, of roll or panel end 1501a, bridges and overlaps with part of the intermediary composite 1505b and first geotextile layer 1507b, of roll or panel end 1501b. The Z-shaped gap 1558, between ends 1501a and 1501b, is filled with a loose sand/bentonite mix 1554 further to prevent any migration of clay silt particles through the joint.

Now referring to FIG. 16 there is shown a further alternative joint between adjacent ends 1601a and 1601b, of adjacent rolls or panels of containment structures of the present invention. Here, the ends 1601a and 1601b are inclined at an angle of 45°, and are positioned such that the facing surfaces of intermediary composite 1605a and 1605b lie parallel to one another, thereby defining the gap 1658, which is consequently formed at an angle of 45°. The gap 1658 is filled with a loose sand/bentonite mix 1654, which improves the efficiency of the seal. The 45° angle between ends 1601a and 1601b ensures that, upon application of a downward force, from a train load for example, the intermediary composite portions 1605a and 1605b are forced together, due to their overlapping nature, thereby providing an effective seal.

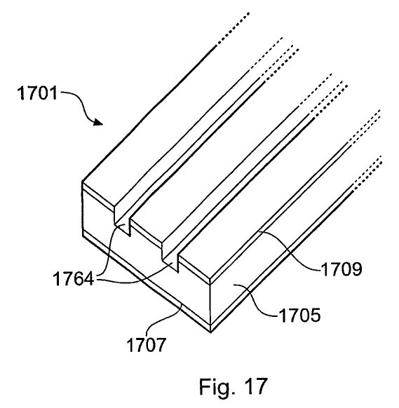

Referring now to FIG. 17 there is shown an alternative embodiment of the present invention, wherein the containment structure, generally indicated 1701, has a pair of longitudinal grooves 1764 formed along one of its major surfaces. It will be understood, however, that the containment structure of the present invention may be provided with a single groove, or a plurality of grooves, the groove(s) being provided along and/or across any part of the structure.

The containment structure 1701, as shown in FIG. 17, has a first geotextile layer 1707, a second geotextile layer 1709, and intermediary composite 1705 held therebetween (open cell matrix not shown in FIG. 17). Depicted by one end of a roll or panel of the present invention, the grooves 1764, in this embodiment, are shown to have a rectangular cross section, and their depth being dependent upon their intended function. For example, the grooves 1764 may be left as an air space, may house microbore tubes, or may be designed for the passage of liquids or gasses.

Referring now to FIG. 18 there is illustrated a containment structure 1801 similar to that shown in FIG. 2. However, in this embodiment, part of the body of intermediary composite material 1805 sits proudly of the dimensions defined by the open-cell matrix 1803. The thickness of the intermediary composite 1805 is, in this embodiment, twice the thickness of the open-cell matrix 1803, and acts to improve the filtration capacity of the containment structure 1801 still further.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A particulate material containment structure, comprising:
an open-cell matrix;
an intermediary composite comprising particulate material retained in a support matrix, wherein the intermediary composite is retained within the open-cell matrix; and
at least one blanket of the intermediary composite.

2. The particulate material containment structure as claimed in claim 1, wherein at least part of the structure is porous.

3. The particulate material containment structure as claimed in claim 1, wherein the structure is permeable.

4. The particulate material containment structure as claimed in claim 1, wherein the structure is impermeable.

5. The particulate material containment structure as claimed in claim 1, wherein the support matrix is formed from a curable material.

6. The particulate material containment structure as claimed in claim 1, wherein the support matrix is flexible.

7. The particulate containment structure as claimed in claim 1, wherein the support matrix comprises a bonding agent.

8. The particulate material containment structure as claimed in claim 1, wherein the support matrix is an adhesive.

9. The particulate material containment structure as claimed in claim 8, wherein the adhesive is latex rubber.

10. The particulate material containment structure as claimed in claim 1, wherein the particulate material is at least one selected from sand, zeolite, recycled glass, and carbon.

11. The particulate material containment structure as claimed in claim 1, wherein the particulate material is uniformly distributed throughout the intermediary composite.

12. The particulate material containment structure as claimed in claim 1, wherein the open-cell matrix is formed from a synthetic material.

13. The particulate material containment structure as claimed in claim 1, wherein the open-cell matrix is formed from a plastics material.

14. The particulate material containment structure as claimed in claim 1, wherein the open-cell matrix is formed from polyethylene.

15. The particulate material containment structure as claimed in claim 1, wherein the open-cell matrix, in use, is capable of withstanding a compressive load whilst substantially maintaining the positional integrity of the particulate material retained within the intermediary composite of the structure.

16. The particulate material containment structure as claimed in claim 1, wherein the blanket of particulate material is located adjacent a major surface of the open-cell matrix.

17. The particulate material containment structure as claimed in claim 1, further comprising a wetting agent.

18. The particulate material containment structure as claimed in claim 1, wherein the intermediary composite is uniformly distributed within the open-cell matrix.

19. The particulate material containment structure as claimed in claim 1, further comprising at least one textile layer.

20. The particulate material containment structure as claimed in claim 19, wherein the open-cell matrix and the intermediary composite are sandwiched between at least two textile layers.

21. The particulate material containment structure as claimed in claim 19, wherein the textile layer is a geotextile layer.

22. The particulate material containment structure as claimed in claim 19, wherein, in use, the textile layer is capable of spreading a load imparted on the structure.

23. The particulate material containment structure as claimed in claim 1, further comprising staple fibers.

24. The particulate material containment structure as claimed in claim 1, further comprising radio frequency identification means.

25. A method of manufacturing a particulate material containment structure, the structure being porous, and the method comprising the steps of:
a) forming an intermediary composite comprising particulate material retained in a support matrix;
b) adding the intermediary composite to an open-cell matrix for containment therein; and
c) providing at least one blanket of the intermediary composite.

26. The method as claimed in claim 25, further comprising the step of laminating at least one textile layer to the open-cell matrix.

27. The method as claimed in claim 26, wherein the textile layer is rolled on to the open-cell matrix during lamination.

28. The method as claimed in claim 25, further comprising the step of utilizing a thickness adjustment means to select the thickness of the structure.

29. The method as claimed in claim 26, wherein one textile layer is laminated to the open-cell matrix before adding of the intermediary composite, thereby defining filling pockets for receiving intermediary composite within the open-cell matrix.
